(19) United States
(12) Patent Application Publication
(10) Pub. No.: US 2008/0034556 A1
(43) Pub. Date: Feb. 14, 2008

(54) Cord lock device

(76) Inventor: Tsung Neng Liao, Taichung (TW)

Correspondence Address: CHARLES E. BAXLEY, ESQ., 90 JOHN STREET, THIRD FLOOR, NEW YORK, NY, 10038, US

(21) Appl. No.: 11/501,938

(22) Filed: Aug. 9, 2006

(51) Int. Cl. F16G 11/00

(52) U.S. Cl. 24/132 R

(57) ABSTRACT

A cord lock device includes a seat extended from a base for engaging with a cord and a shaft also extended from the base, and a pawl rotatably engaged onto the shaft and having a protrusion for engaging with the cord and for clamping and sandwiching the cord between the protrusion of the pawl and the seat of the plate member when the pawl is rotated in an active direction relative to the shaft, and the cord may be released from the protrusion of the pawl and the seat of the plate member when the pawl is rotated in a reverse direction relative to the shaft. The pawl and the seat may include a number of teeth for frictionally engaging with the cord. The base includes a projection having an orifice for receiving the cord.

### BACKGROUND OF THE INVENTION

1. Field of the Invention

The present invention relates to a cord lock device, and more particularly to a cord lock device including a simplified structure for allowing the cord to be easily and quickly locked or fastened to the cord lock device and also to be easily and quickly unlocked or unfastened or released from the cord lock device with a single hand of the user.

2. Description of the Prior Art

Typical shoes or clothes comprise one or more cord lock devices or fastening devices attached thereon for engaging with the shoe laces or strings and/or the cloth ropes, or the like and for releasably locking or fastening the shoe laces or strings and/or the cloth ropes to the shoes or the clothes.

For example, U.S. Pat. No. 3,138,839 to Mathes discloses one of the typical tie ends securing devices comprising a base and a cap for clamping a cord or rope therebetween, and two holes or openings formed in the cap for receiving or threading the cord or rope. However, the typical tie ends securing device includes a complicated configuration that may not be operated with a single hand of the user.

U.S. Pat. No. 4,102,019 to Boden discloses another typical locking assembly comprising a body including a central passage formed therein for engaging with a cord or rope, and a shiftable locking slide slidably received in the central passage of the body for engaging with the cord or rope and for releasably locking or fastening the cord or rope to the body. However, similarly, the typical locking device includes a complicated configuration that may not be operated with a single hand of the user.

U.S. Pat. No. 4,336,636 to Ishiguro et al. discloses a further typical fastening device comprising a casing including a pair of inwardly folded portions, and a pair of symmetrical block members each having a chamber formed therein for engaging with or for threading a cord or rope and for being biased to engage with the cord or rope and for releasably locking or fastening the cord or rope to the casing. However, similarly, the typical fastening device includes a complicated configuration that may not be operated with a single hand of the user.

The present invention has arisen to mitigate and/or obviate the afore-described disadvantages of the conventional cord lock devices.

### SUMMARY OF THE INVENTION

The primary objective of the present invention is to provide a cord lock device including a simplified structure for allowing the cord to be easily and quickly locked or fastened or secured to the cord lock device and also to be easily and quickly unlocked or unfastened or released from the cord lock device with a single hand of the user.

In accordance with one aspect of the invention, there is provided a cord lock device comprising a base including a seat extended from the base for engaging with a cord, and including a shaft extended from the base, and a pawl rotatably engaged onto the shaft and including a protrusion extended therefrom for engaging with the cord and for clamping and sandwiching the cord between the protrusion of the pawl and the seat of the plate member when the pawl is rotated in an active direction relative to the shaft, and the cord is arranged to be released from the protrusion of the pawl and the seat of the plate member when the pawl is rotated in a reverse direction relative to the shaft.

The pawl includes a number of teeth extended therefrom for frictionally engaging with the cord. The seat may also include a number of teeth extended therefrom for frictionally engaging with the cord.

The base includes a projection extended therefrom and having an orifice formed therein for receiving the cord and for stably anchoring the cord to the base. The projection is located beside the seat.

The pawl includes a peg extended therefrom for engaging with the base and for limiting the pawl to rotate relative to the shaft and the base. For example, the base includes a peripheral channel formed therein and located around the shaft for slidably receiving the peg of the pawl.

The base includes a fastener engaged with the pawl and the shaft for rotatably anchoring the pawl to the shaft. The base includes a compartment formed in the shaft for receiving the fastener, the pawl includes a peripheral shoulder formed therein, and the fastener includes an enlarged head engaged into the peripheral shoulder of the pawl for rotatably anchoring the pawl to the shaft.

A spring biasing device may further be provided for biasing the pawl to rotate relative to the shaft and includes a spring member engaged between the pawl and the shaft for biasing the pawl to rotate relative to the shaft. The pawl includes a space for receiving the spring member. The pawl includes a slit formed therein, and the spring member includes one end portion engaged with the slit of the pawl. The shaft includes a slot formed therein, and the spring member includes the other end portion engaged with the slot of the shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view illustrating an attachment of a cord lock device in accordance with the present invention onto an object, such as a shoe;

FIG. 2 is a perspective view of the cord lock device;

FIG. 3 is a cross sectional view of the cord lock device taken along lines 3-3 of FIG. 2;

FIG. 4 is an exploded view of the cord lock device;

FIG. 5 is a cross sectional view of the cord lock device taken along lines 5-5 of FIG. 4;

FIGS. 6, 7, 8 are perspective views similar to FIG. 2, illustrating the operation of the cord lock device;

FIG. 9 is a perspective view of a cloth having a cord lock device in accordance with the present invention attached thereon for releasably locking or fastening the cord or rope to the cloth; and

FIG. 10 is an enlarged partial perspective view illustrating the attachment of the cord lock device to the cloth.

### DETAILED DESCRIPTION OF THE PREFERRED EMBODIMENT

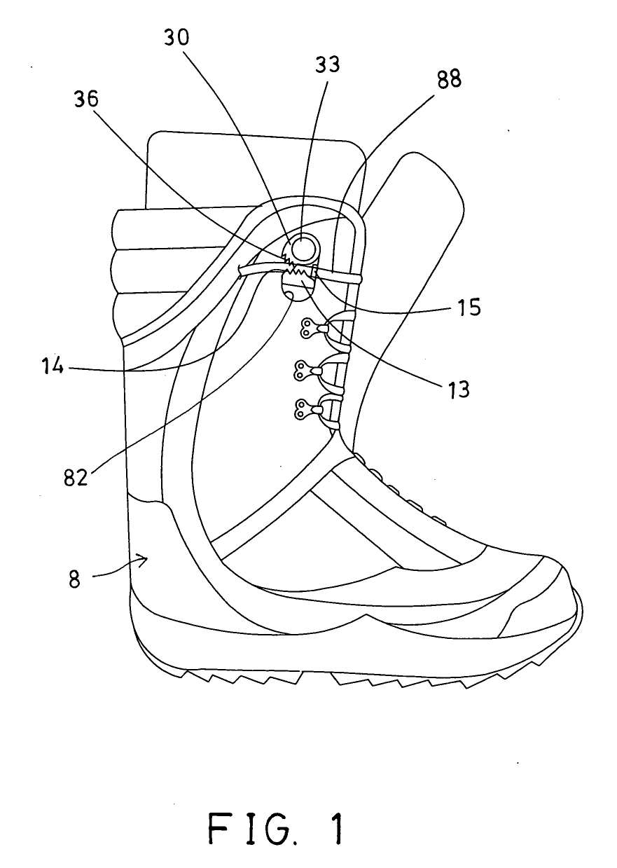

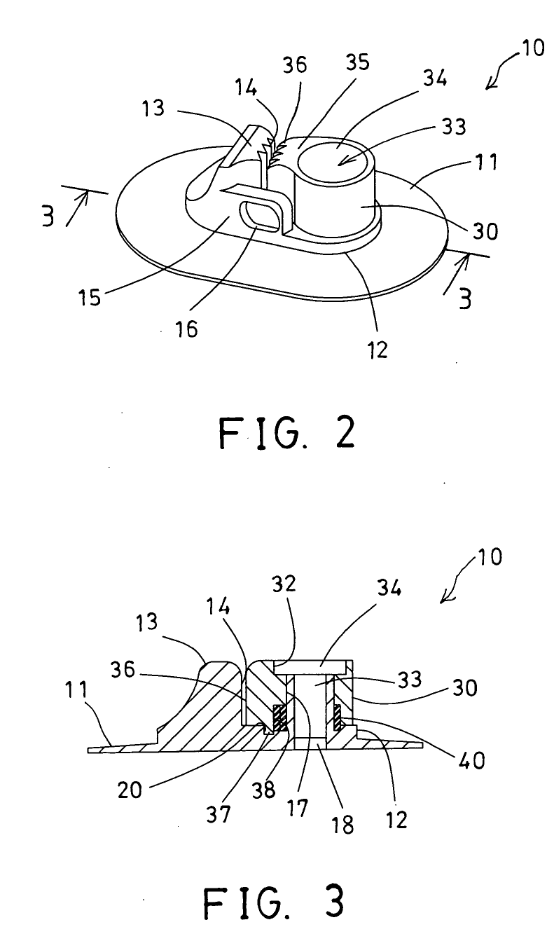

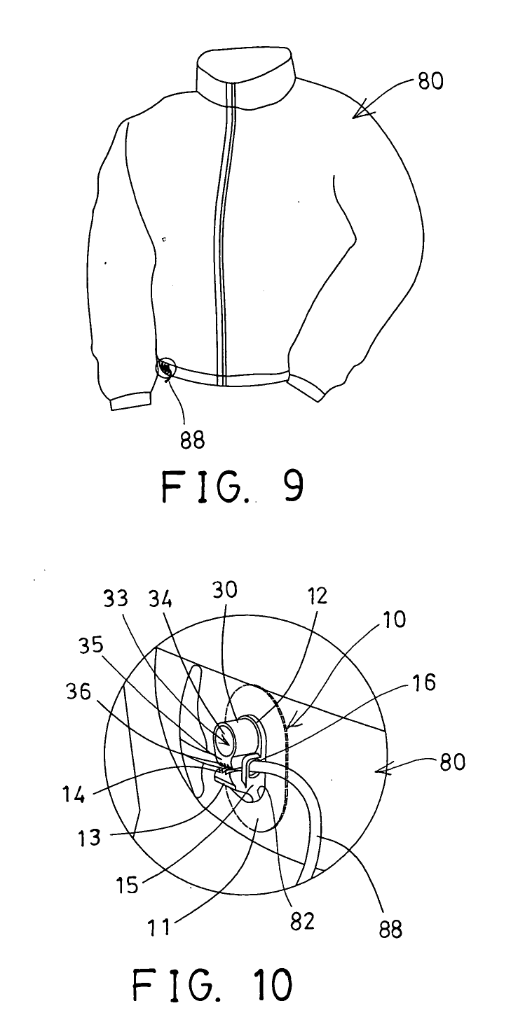

Referring to the drawings, and initially to FIG. 1, a cord lock device 10 in accordance with the present invention is provided for attaching onto various supporting objects 8, such as a shoe 8 (FIG. 1), a cloth 80 (FIGS. 9, 10), or the like and for releasably locking or fastening a typical rope or cord 88 to the shoe 8 or to the cloth 80 (FIGS. 1, and 6-10). As shown in FIGS. 1-4, the cord lock device 10 comprises a body or plate member 11 for being disposed in or engaged into the supporting objects 8 and for being secured to the supporting objects 8 with such as latches or fasteners or buckles (not shown), stitches or adhesive materials, or by welding processes, or the like. The plate member 11 may also be secured to the outer portion of the supporting objects 8.

The plate member 11 of the cord lock device 10 includes a bulge or base 12 extended upwardly from the body or plate member 11 for engaging with or through an opening 82 of the supporting objects 8 (FIGS. 1, 10) and thus for further anchoring the cord lock device 10 to the supporting objects 8 and for preventing the cord lock device 10 from being moved laterally or sidewise relative to the supporting objects 8, and thus for allowing the base 12 to be extended out of the supporting objects 8. The cord lock device 10 further includes a swelling or seat 13 extended upwardly or outwardly from the base 12 and having a serrated surface or a number of teeth 14 extended therefrom for frictionally engaging with the cord 88 (FIGS. 1, 6, 7, 10).

The cord lock device 10 further includes a projection 15 extended upwardly or outwardly from the base 12 and/or extended laterally from the seat 13 and/or located beside the seat 13 and having an orifice 16 formed therein for receiving or engaging or threading the cord 88 and thus for stably anchoring the cord 88 to the base 12 or the plate member 11 of the cord lock device 10. The plate member 11 or the cord lock device 10 further includes a hub or tube or shaft 17 extended upwardly from the plate member 11 and having a compartment 18 formed therein and having a slot 19 formed in the outer peripheral portion thereof. The plate member 11 or the cord lock device 10 further includes a peripheral channel 20 formed in the upper portion of the plate member 11 or the base 12 and formed or located around the shaft 17.

A follower or pawl 30 includes a bore 31 formed therein for receiving or engaging with the shaft 17 and thus for rotatably attaching or coupling or anchoring the pawl 30 to the shaft 17, and includes an enlarged peripheral recess or shoulder 32 formed in the upper portion of the shaft 17 and communicating with the bore 31 of the pawl 30. A rivet or fastener 33 is engaged into the bore 31 of the pawl 30 and also engaged into the compartment 18 of the shaft 17 for rotatably locking or anchoring or fastening the pawl 30 to the shaft 17, and includes an enlarged head 34 provided on the upper portion of the fastener 33 and engaged into the peripheral shoulder 32 of the pawl 30 for further stably and rotatably locking or anchoring or fastening the pawl 30 to the shaft 17.

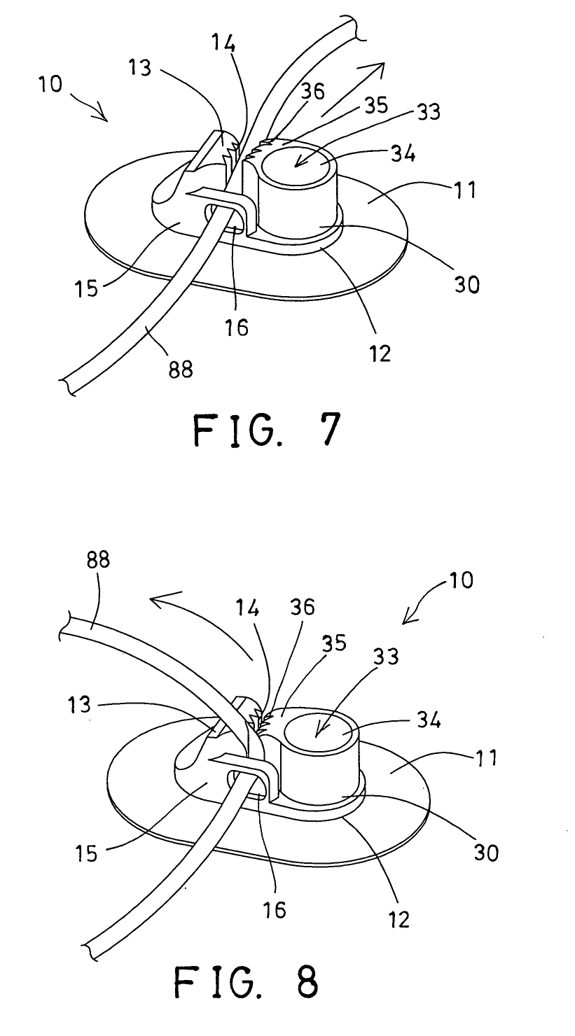

The pawl 30 includes a protrusion 35 extended therefrom for engaging with the cord 88 and arranged for allowing the cord 88 to be engaged with or sandwiched or clamped or retained between the protrusion 35 of the pawl 30 and the seat 13 of the plate member 11 (FIGS. 6, 7). It is preferable that the pawl 30 includes a number of teeth 36 extended from the protrusion 35 for frictionally engaging with the cord 88 and for further stably anchoring or clamping the cord 88 between the protrusion 35 of the pawl 30 and the seat 13 of the plate member 11. It is arranged that the protrusion 35 or the teeth 36 of the pawl 30 will be caused to solidly engage with the cord 88 when the pawl 30 is rotated in an active direction relative to the shaft 17, or to release the cord 88 when the pawl 30 is rotated in a reverse or a release direction relative to the shaft 17.

In operation, as shown in FIG. 6, the protrusion 35 or the teeth 36 of the pawl 30 are arranged to be forced to rotate relative to the shaft 17 and toward the seat 13 of the plate member 11 by the cord 88 or when the cord 88 is pulled in an active direction or when the pawl 30 is rotated in the active direction relative to the shaft 17, for allowing the cord 88 to be tightly fastened or clamped or retained between the protrusion 35 of the pawl 30 and the seat 13 of the plate member 11. As shown in FIG. 7, when the cord 88 is pulled in a reverse direction or when the pawl 30 is rotated in the reverse or release direction relative to the shaft 17, the cord 88 may be released from the protrusion 35 of the pawl 30 and the seat 13 of the plate member 11.

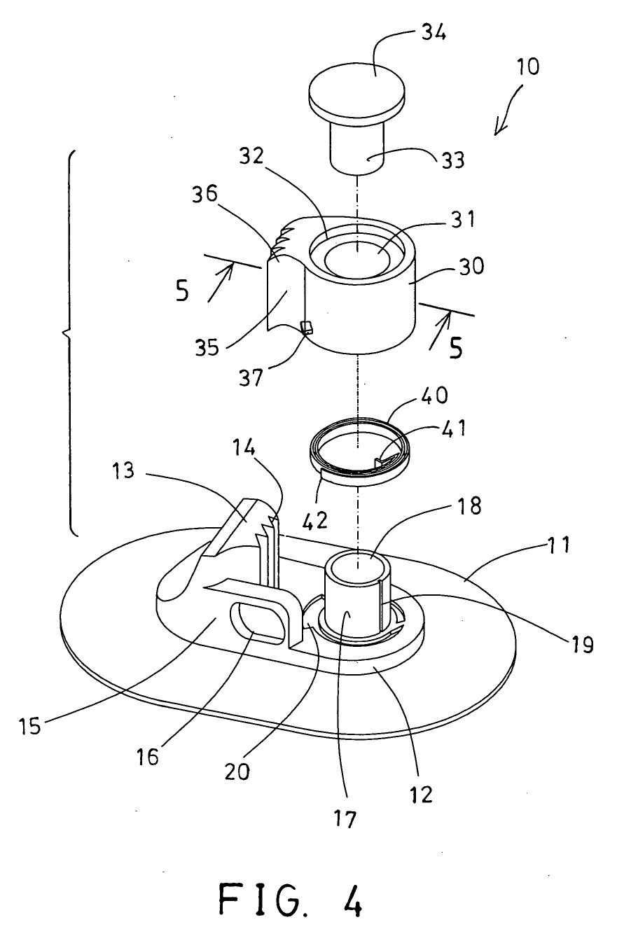

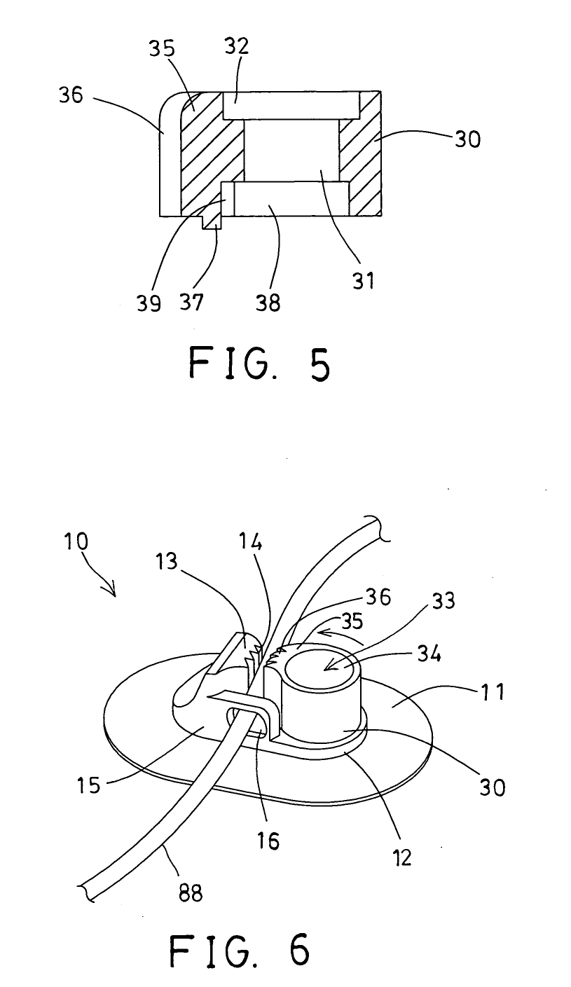

The pawl 30 includes a key or peg 37 extended downwardly from the lower portion thereof (FIGS. 4, 5) for slidably engaging with the peripheral channel 20 of the plate member 11 (FIG. 3) and for limiting the pawl 30 to rotate relative to the shaft 17 or for limiting the protrusion 35 or the teeth 36 of the pawl 30 to rotate relative to the seat 13 of the plate member 11 and thus for allowing the cord 88 to be suitably tightened or fastened or clamped or retained between the protrusion 35 of the pawl 30 and the seat 13 of the plate member 11 or to be released from the protrusion 35 of the pawl 30 and the seat 13 of the plate member 11. As shown in FIG. 8, the cord 88 may also be directly pulled away from the protrusion 35 of the pawl 30 and the seat 13 of the plate member 11 for allowing the cord 88 to be quickly released from the protrusion 35 of the pawl 30 and the seat 13 of the plate member 11.

As shown in FIGS. 3-5, the pawl 30 further includes an enlarged space 38 formed in the lower portion thereof and also communicating with the bore 31 of the pawl 30 for receiving a spring biasing means or spring member 40, such as a coil spring member 40 therein, and includes a slit 39 formed therein and communicating with the enlarged space 38 of the pawl 30. The spring member 40 includes one end portion 41 (FIG. 4) for engaging with the slot 19 of the shaft 17, and the other end portion 42 for engaging with the slit 39 of the pawl 30 for allowing the spring member 40 to apply a spring biasing force against the pawl 30 and for biasing the protrusion 35 or the teeth 36 of the pawl 30 to frictionally engage with the cord 88 and to suitably clamp or retain the cord 88 between the protrusion 35 of the pawl 30 and the seat 13 of the plate member 11.

In operation, as shown in FIGS. 6-8, the user may only use his one hand to pull the cord 88 and to suitably engage the cord 88 between the protrusion 35 of the pawl 30 and the seat 13 of the plate member 11 (FIG. 6), or to release the cord 88 from the protrusion 35 of the pawl 30 and the seat 13 of the plate member 11 (FIG. 7), or to directly disengage the cord 88 from the protrusion 35 of the pawl 30 and the seat 13 of the plate member 11 (FIG. 8), such that the cord lock device 10 may be easily used or operated with a single hand of the user. The cord lock device 10 may also be suitably attached onto various supporting objects 8.

Accordingly, the cord lock device in accordance with the present invention includes a simplified structure for allowing the cord to be easily and quickly locked or fastened or secured to the cord lock device and also to be easily and quickly unlocked or unfastened or released from the cord lock device with a single hand of the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cord lock device comprising:
a base including a seat extended from said base for engaging with a cord, and including a shaft extended from said base, and
a pawl rotatably engaged onto said shaft and including a protrusion extended therefrom for engaging with said cord and for clamping and sandwiching said cord between said protrusion of said pawl and said seat of said plate member when said pawl is rotated in an active direction relative to said shaft, and
said cord being arranged to be released from said protrusion of said pawl and said seat of said plate member when said pawl is rotated in a reverse direction relative to said shaft.

2. The cord lock device as claimed in claim 1, wherein said pawl includes a plurality of teeth extended therefrom for frictionally engaging with said cord.

3. The cord lock device as claimed in claim 1, wherein said seat includes a plurality of teeth extended therefrom for frictionally engaging with said cord.

4. The cord lock device as claimed in claim 1, wherein said base includes a projection extended therefrom and having an orifice formed therein for receiving said cord and for stably anchoring said cord to said base.

5. The cord lock device as claimed in claim 4, wherein said projection is located beside said seat.

6. The cord lock device as claimed in claim 1, wherein said pawl includes a peg extended therefrom for engaging with said base and for limiting said pawl to rotate relative to said shaft and said base.

7. The cord lock device as claimed in claim 6, wherein said base includes a peripheral channel formed therein and located around said shaft for slidably receiving said peg of said pawl.

8. The cord lock device as claimed in claim 1, wherein said base includes a fastener engaged with said pawl and said shaft for rotatably anchoring said pawl to said shaft.

9. The cord lock device as claimed in claim 8, wherein said base includes a compartment formed in said shaft for receiving said fastener, said pawl includes a peripheral shoulder formed therein, and said fastener includes a head engaged into said peripheral shoulder of said pawl for rotatably anchoring said pawl to said shaft.

10. The cord lock device as claimed in claim 1 further comprising means for biasing said pawl to rotate relative to said shaft.

11. The cord lock device as claimed in claim 10, wherein said biasing means includes a spring member engaged between said pawl and said shaft for biasing said pawl to rotate relative to said shaft.

12. The cord lock device as claimed in claim 11, wherein said pawl includes a space for receiving said spring member.

13. The cord lock device as claimed in claim 11, wherein said pawl includes a slit formed therein, and said spring member includes one end portion engaged with said slit of said pawl.

14. The cord lock device as claimed in claim 11, wherein said shaft includes a slot formed therein, and said spring member includes one end portion engaged with said slot of said shaft.
